(19) United States
(12) Patent Application Publication
(10) Pub. No.: US 2014/0114861 A1
(43) Pub. Date: Apr. 24, 2014

(54) HAND-HELD SELF-PROVISIONED PIN PED COMMUNICATOR

(71) Applicants: Kenneth G. Mages, Chicago, IL (US); Keith Benson, Reston, VA (US); Alan J. Morgan, La Grange, IL (US)

(72) Inventors: Kenneth G. Mages, Chicago, IL (US); Keith Benson, Reston, VA (US); Alan J. Morgan, La Grange, IL (US)

(21) Appl. No.: 13/991,939

(22) PCT Filed: Dec. 9, 2011
(86) PCT No.: PCT/US2011/064173

§ 371 Date: Aug. 9, 2013

Related U.S. Application Data
(60) Provisional application No. 61/421,331, filed on Dec. 9, 2010.

(51) Int. Cl. G06Q 20/40; G06Q 20/38

(52) U.S. Cl. CPC G06Q 20/4012; G06Q 20/3821
USPC 705/71; 705/72

(57) ABSTRACT

A device for storing and transmitting information stored data cards preferably includes a case, a central processing unit (CPU), an operating system, a keypad, a screen display, a secure memory device and a transmission element. A PIN must be entered through the keyboard to operate the electronic card device. The PIN is stored in the secure memory device, Data cards may be entered through a card swipe, a global platform smart card device, a NUMI Key system and manual entry. The transmission element includes a programmable magnetic stripe. The programmable magnetic stripe is programmed to replicate the data on a magnetic stripe of a card. A programmable magnetic stripe is readable by a card transaction device. The operating system displays the cards retained in the memory device through the screen display. The electronic card device preferably includes a global platform smart card device for reading and writing NFC data. Inputs and presentments are performed primarily by end user self-provisioning.

### CROSS-REFERENCES TO RELATED APPLICATION

This application claims priority from Provisional Application Ser. No. 61/421,331, filed on Dec. 9, 2010, which application is incorporated herein by reference in its entirety.

### BACKGROUND OF THE INVENTION

1. Field of the Invention

The present invention relates generally to hand-held electronic devices and more specifically to hand-held devices for storing and securely transmitting stored information obtained from information sources such as, but not limited to, payment cards, smart cards and diverse sources of financial and nonfinancial data or other types of information, which provide securely retaining a plurality of informations such as, but not limited to, informations containing necessary data for enabling credit/debit transactions for multiple accounts for one or more authenticated users and other devices' secure information transmission.

2. Discussion of the Prior Art

U.S. Pat. No. 6,747,547 to Benson discloses a communication method and apparatus improvements and U.S. Pat. No. 7,810,729 to Morley, Jr, discloses a card reader device for a cell phone and method of use. The Benson and Morely patents are hereby incorporated into this patent application by reference in their entirety. Published U.S. Patent Applications 2011/0276416, 2011/0276437, 2011/0282753, 2011/0284640 and 2011/0284632 to Mullen et al. disclose relevant payment card devices which are also incorporated by reference in their entirety. U.S. Pat. Nos. 7,784,687, 7,793,851, 8,020,775 and 7,954,705 to Mullen et al. disclose relevant payment card devices which are incorporated herein by reference in their entirety.

The Payment Card Industry (PCI) has developed a standard for personal identification numbers (PIN) and Transaction Security (PTS). The specifications of PTS are embodied in its published standards entitled “Device Testing Approved Program Guide”, Version 1.1, dated October 2011, which is a thirty-three page document which is incorporated herein by reference in its entirety. The aforementioned PTS standard is used to secure information transfers involving financial transactions, for example, a user interface of an ATM machine. The PIN is securely entered by being encrypted at the interface by a user and transferred through a hard wired connection to a computer system implementing the PTS standard.

Currently there are essentially two ways to interact with nearfield communications (NFC)/radio frequency identification (RFD) NFC/RFID. One simple way is a fob carried on ones key-chain to purchase gasoline. Such a fob is a passive device, which contains pertinent user information relevant to some payment card instrument tied to the user's account. When this fob is within proximity (approximately 4 inches) of an NFC/RFID reader, a magnetic field is generated causing the fob to transmit a radio wave moving the pertinent data from the fob to the near field communication reader enabling the user to make a purchase at the gas pump. Another similar example is a toll road transmitter typically placed in the windshield of one's automobile. Upon approaching a toll booth, the magnetic field generated by the tollbooth stimulates the transmitter in the automobile to generate a radio frequency identification, which validates the user and the payment card instrument in order to pay the toll without actual coins. Typically such devices are coupled to one's credit or debit or bankcard and upon reaching a preestablished minimum threshold, more funds are moved from one user account to the account that supplies funds for the toll (decoupled debit).

In the above example, NFC/RFID is the transfer protocol layer upon which data is moved from a user's payment card instrument to a payment receiving instrument (such as a point of sale cash register) to facilitate a financial transaction. Another example of NFC/RFID utility is the addition of information to a sticker or some other printed material, which can be interpreted by an NFC/RFID reader. An example of this would be a sticker below a painting in a museum whereby an NFC/RFID reader when coming in proximity to the sticker, instantiates a reading of the data in the sticker in such a way that the reader can take that information which it has received in the physical world and perhaps migrate that data into the virtual world using for example, a browser, a computer application, a music player, a video player and the like.

The manufacturing of a fob, such as in the example above, is relatively inexpensive. However the example of the near field communication reader described above is typically costly, as it requires a battery, a microprocessor, and the necessary components to read NFC stickers/tags. Recently, major cellular phone manufacturers such as Apple, Google, Nokia, and others are proposing that NFC/RFID readers and writers will be standard in handsets. For a select segment, such handsets will provide utility so that users can add payment card information to the handsets in order to turn said handsets into virtual wallets. The same handset will also allow the user to read near field communication stickers in the physical world and have that data redirect the handset to a specific application or a browser for an experience that merges or converges the physical world with the virtual world.

Accordingly, there is a clearly felt need in the art for a device for storing and transmitting information stored on data cards, which provides a secure method of retaining a plurality of data cards and the like.

### SUMMARY OF THE INVENTION

The present invention provides a device for scanning, securing, storing and securely transmitting stored information stored on, for example, without limitation, financial transaction cards with a magnetic strip or embedded integrated circuit processor (Smart Card), which provides a secure method of retaining a plurality of different secure informations, such as but not limited to, use with financial transactions at point of sale (POS) terminals or other diverse terminals or in secure peer-to-peer communications.

The device for storing and transmitting information in accordance with the invention, such as stored on data cards (electronic card devices), preferably includes a case, a central processing unit (CPU), an operating system, a keypad, a screen display, a memory device and a transmission element. A data card includes, but is not limited to payment cards, ATM cards and bar code loyalty cards.

The CPU receives operator input directly from the keypad and the screen display. The CPU is preferably Payment Card Industry (CPI) compliant and preferably includes a tamper proof module (TPM). A PIN must be entered through the keyboard to operate the electronic card device. The PIN is preferably encrypted with known derived unique key per transaction (DUKPT) encryption software to form a PED and prevent hacking of the electronic card device. Preferably, an incorrect PIN may be entered only three times at which point the device is disabled.

Data cards and other diverse types of information may be input into the electronic device of the invention with one or more of a card swipe, a global platform smart card device, a NUMI Key system and manual entry. The electronic device of the invention may be attached to the card swipe, which allows information from a card with a magnetic stripe to be entered into the electronic device. The global platform smart card device is resident in the electronic card device. The global platform smart card device reads data cards with RFID/NFC chips. The well-known NUMI Key system (described, for example, at numikey.com) is preferably resident in the electronic card device. The NUMI Key system allows bar code loyalty cards to be read and written. The manual entry occurs through an electronic device, such as a personal computer or smart phone. Information from a data card or other sources is input into the processor of the device in accordance with the invention and stored in a hardware security module (HSM) memory device in accordance with Payment Card Industry (PCI) Hardware Security Module (HSM) Security Requirements, Version 1.0, April 2009.

The operating system displays the encrypted data cards retained in the HSM memory device through the screen display, which may be a source of information transmitted to another device or network. Card information stored in the HSM memory device is transmitted (or presented) through the transmission element, the global platform smart card device or the NUMI Key system. The transmission element preferably includes a programmable magnetic stripe and a programmable Europay Master Card Visa integrated circuit (programmable EMV integrated circuit). The programmable magnetic stripe is temporarily programmed with the same data that is retained in the magnetic stripe of a card or other information stored in the HSM. The programmable magnetic stripe is electrically programmed by the processor to have a binary number, which is the same as the magnetic stripe of the card. The programmable EMV integrated circuit is electrically programmed by the processor to have a binary number, which is the same as the programmable EMV integrated circuit.

The transmission stripe is read by a card transmission terminal or other device, such as a point of sale payment card reader. The transmission stripe only retains the magnetic stripe data of the card for only one swipe at the point of sale payment card reader. The global platform smart card device transmits or writes a nearfield communication (NFC) image to a nearfield communication (NFC) reader plate. The NUMI Key system is capable of writing or transmitting bar code information from a bar code loyalty card to a bar code reading device.

Each electronic device of the invention includes a unique identification number (private key). A user of the electronic device is assigned a code by a third party verification organization. The third party verification organization establishes the identity of users through an authentication process, similar to how a payment card company or bank establishes the identity of a payment card user. The electronic card device also includes a SIM (Subscriber Identification Module) card, which is also verified by the third party verification organization during the authentication process. This action pairs the private key described above to a public key.

Accordingly, the present invention provides an electronic device, which provides a secure method of retaining an identity of a plurality of magnetic stripe cards, other cards or other forms of stored information to enter into information exchange with another device (peer-to-peer) or a network, such as, but not limited to, a payment card verification method of a card issuer.

The present invention also provides an electronic device, which requires entry of a secure pin to access the information stored therein so as to provide it in a secure form to another device or network.

The present invention further provides an electronic device, which works with point of sale payment card readers and NFC plate readers.

The present invention further provides an electronic device, which reads and writes NFC data.

The present invention also provides an electronic device, which includes a processor within a tamper-proof module.

The present invention facilitates the functions specified above very inexpensively, very simply, and without the need for a specific cellular handset which has built in NFC/RFD protocols. The invention itself will enable a user to load multiple payment card instruments or other data forms and to secure those dates with a personal identification number (PIN) so that if the invention is misplaced, lost or stolen the stored information that has been input will be secured by the PIN. This invention will also allow a user to touch or come in appropriate proximity with an NFC/RFID sticker to gather the information on the sticker or apply new data to an existing sticker and have that data read asynchronously or synchronously with a network connected terminal. An example is that a user upon seeing the sticker below the painting in the museum merely and quickly retrieves the data from the NFC/RFID sticker or ads a comment to the information upon that sticker. However, the user will not be able to upload the information that he or she has taken or added to the sticker until the user is authenticated by entry of his other PIN and the invention is connected to a network terminal such as a cellular phone, a PC, or a set top box etc.

A benefit of the invention is that because it is designed to preferably perform one task at a time and all the data is secured in hardware within the Invention, there is a layer of security provided heretofore not in existence exclusive of PCI terminals. In essence, this invention behaves much like an older technology, the floppy disk, where one might compose a document on one computer, save the information to the floppy disk, move the floppy disk to another computer for editing or printing, thereby creating what was formerly known as “a sneaker network”. Of course without some encryption methodology, the floppy disk if lost, stolen, or found by an undesired or adversarial user could have its contents abused, stolen, or altered. By adding the necessity or the option for users to protect the data collected on their device with a PIN provisioned and authenticated to be the user's, the risk of secure data being abused is reduced to near zero.

A user hand-held device for securely transmitting stored information from the device to another device or network for further processing of the stored information in accordance with an embodiment of the invention includes a processor including a trusted platform module for encrypting and decrypting personal identification numbers of potential users of the device to determine if a user inputting a personal identification number is a provisioned and authenticated user of the device; a pin entry device hard wired to the processor for entry and creation of at least one personal identification number of a potential user of the device into an encrypted personal identification number block which at a time of use is used to determine if the user of the hand-held device is authenticated to permit a subsequent data transfer of the stored information between the device and another device or the network; a memory for storing at least one encrypted personal identification number identifying at least one authenticated user of the hand-held device prior to use of the device by the at least one authenticated user; and wherein the pin entry device is compliant with the Device Testing and Approval Program Guide, Version 1.1, October 2011, of the Payment Card Industry (PCI), PIN Transaction Security (PTS) and the processor communications with the pin entry device to determine if the user is an authenticated user of the hand-held device by comparing the personal identification number entered by the user on the pin entry device to determiner if there is a match with at least one authorized stored personal identification number and upon determining if a match exists, the device communicates the information between the device and the another device or the network (the memory may comprise a hardware storage module). The encrypting and decrypting may be in accordance with DUKPT encryption and decryption. The device may further include a reader of Smart Cards and/or a reader of cards having an encoded magnetic stripe.

A user device for securely transmitting stored information from the device to another device or network for further processing of the stored information in accordance with an embodiment of the invention includes a processor including a trusted platform module for encrypting and decrypting personal identification numbers of potential users of the device to determine if a user inputting a personal identification number is a provisioned and authenticated user of the device; a pin entry device hard wired to the processor for entry and creation of at least one personal identification number of a potential user of the device into an encrypted personal identification number block which at a time of use is used to determine if the user of the hand-held device is authenticated to permit a subsequent data transfer of the stored information between the device and the another device or the network; a memory for storing at least one encrypted personal identification number identifying at least one authenticated user of the hand-held device prior to use of the device by the at least one authenticated user; and wherein the pin entry device is compliant with the Device Testing and Approval Program Guide, Version 1.1, October 2011, of the Payment Card Industry (PCI), PIN Transaction Security (PTS) and the processor communications with the pin entry device to determine if the user is an authenticated user of the hand-held device by comparing the personal identification number entered by the user on the pin entry device to determiner if there is a match with at least one authorized stored personal identification number and upon determining if a match exists, the device communicates the information between the device and the another device or the network (the memory may comprise a hardware storage module). The encrypting and decrypting may be in accordance with DUKPT encryption and decryption. The device may further include a reader of Smart Cards and/or a reader of cards having an encoded magnetic stripe.

A hand-held consumer electronics data collection, storage and retransmission device in accordance with the invention is an apparatus which is adapted to receive, store and retransmit data from time to time with respect to the identification of the user; includes means to hold a security element module within the apparatus which can provide for authentication of the user to an external interrogation from time to time, characterized in that it includes processor means connected to electrical contacts adapted to connect with an appropriate security element; a processor means configured to receive RFID input signals and adapted, in case the RFID signals are appropriate for being stored in the consumer electronic apparatus to effect a direction of such incoming inquiry signals to the appropriate memory within the apparatus; and in the event of an interrogation from a network connected device for identification or other authentication purposes, as appropriate to direct such interrogation to memory means comprising an active or passive authentication or identification means, so that an identification or authentication process is available through the network connected device, the network connected device receiving at least part of its data in response to its interrogation, from a peripheral device(s) which is/are directly and securely connected using tamper-resistant methods to the apparatus security element, and only one I/O process is allowed at any given time by the apparatus' CPU not to include multi-threaded I/O processes. The peripheral device may be one or more of PED keypad, keyboard, MAG reader, ISO 7861 reader or the like. The retransmission may be effected by one or more of a USB, Blue-Tooth Connection, REID, RS 232 connection, earjack connection or the like and a synchronous record of the data is stored in the apparatus and forwarded to a remote, user accessible activity log and a secure database. Data from the apparatus is stored in a secure database. A security element is one of a Global platform Smart Card PCI certified chipset, TPM chipset, SIM card, secure SD card or the like. A security scheme is one of 3 DES, DUKPT, AES, RSA or the like. A communication protocol is one of DASH-7, NFC, GPRS RS 232 or the like.

### BRIEF DESCRIPTION OF THE DRAWINGS

FIG. 1 is a top perspective view of a first embodiment of a device in accordance with the present invention.

FIG. 2 is a bottom perspective view of the first embodiment of a device in accordance with the present invention.

FIG. 3 is a perspective of a magnetic card swipe attached to the device in accordance with the first embodiment of the present invention.

FIG. 4 is a schematic diagram of the first embodiment of the device in accordance with the present invention.

FIG. 5 is a perspective view of a second embodiment 100 of the invention scanning a sticker.

FIG. 6 is a perspective view of the second embodiment 100 of the invention compared in size to a payment card.

FIG. 7 is a schematic view of the second embodiment of the invention comprising an action/transaction.

FIG. 8 is a schematic diagram of the second embodiment of the invention.

FIG. 9 is an exploded view of the first embodiment of the invention.

FIG. 10 is a view of the process of using the first embodiment of the invention.

### DETAILED DESCRIPTION OF THE PREFERRED EMBODIMENTS

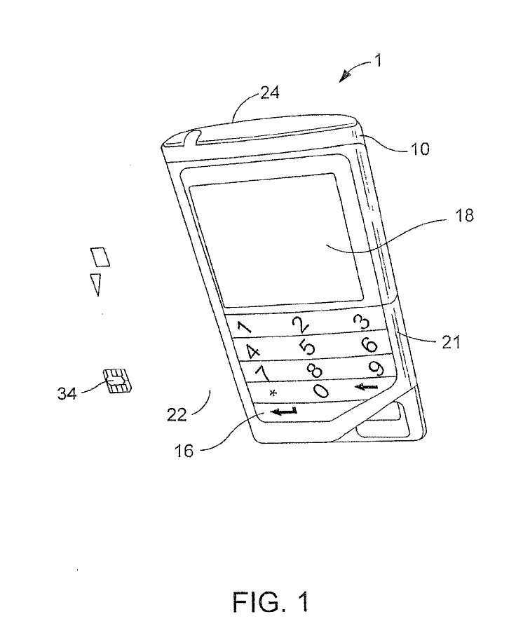

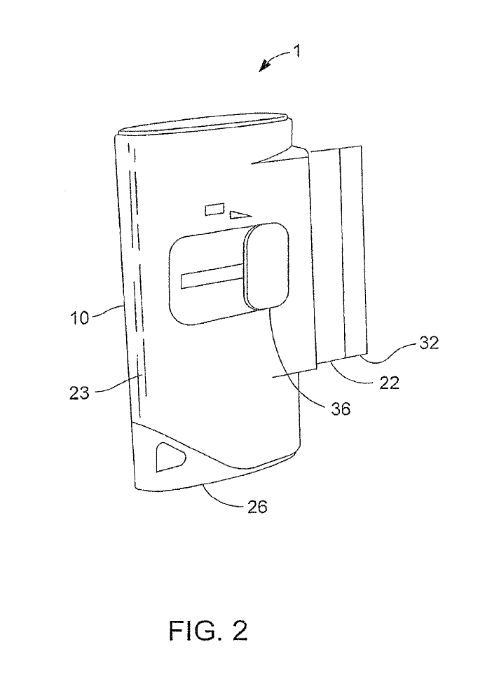

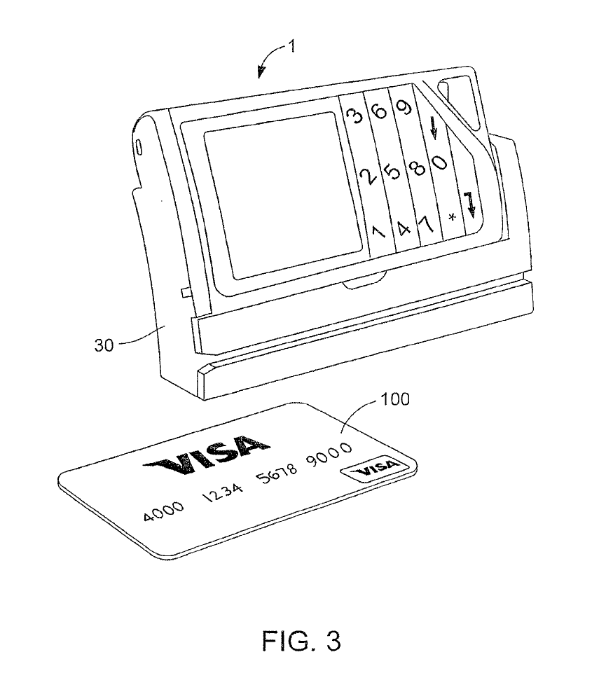

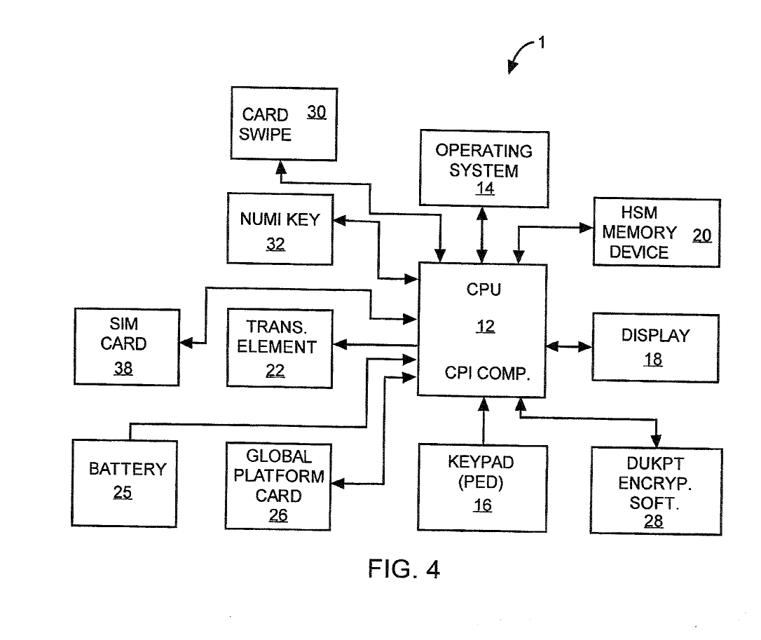

FIG. 1 shows a top view of an electronic card device 1. With reference to FIGS. 2 and 4, the electronic card device 1 preferably includes a case 10, a central processing unit (CPU) 12 which contains a processor(s), an operating system 14, a keypad 16 which preferably is part of a PED in accordance with the above standard, a screen display 18, an HSM memory device 20 which is in accordance with the above standard and a transmission element 22 which provides at least four types of output which are, RFID, via reading a magnetic stripe, reading a smart card, an optical readout or NFC output, and the like, The case 10 preferably includes a front case half 21 and a rear case half 23 as illustrated in FIGS. 1 and 3. A well-known paywave card slot 24 is disposed on one end and a known global platform card device 26 is disposed on the other end of the case 10 to provide NFC. The paywave card slot 24 retains a known paywave card to provide a magnetic stripe which is programmed to be read once. The global platform card device 26 allows a nearfield communication (NFC) image to be read and written once. A micro-USB port is preferably retained in the global platform card device 26. The CPU 12 receives operator input directly from the keypad 16 and the screen display processor 18. The CPU/processor 12 is preferably Payment Card Industry (CPI) compliant and preferably includes a known type tamper-proof module (TPM). Preferably a battery 25 is used to supply the electronic components in the electronic card device 1 with electrical power.

A PIN must be entered through the keypad 16 by a provisioned and authenticated user to operate the electronic card device 1. The PIN entries are preferably encrypted with derived unique key per transaction (DUKPT) encryption software 28 to establish a pin entry device (PED) in accordance with the above standard, which prevents hacking of the electronic card device 1. Emulation of part of or all of the PED specification by software is within the scope of the invention as is emulation of the HSM in software. The encrypted PIN number is stored in the HSM memory device. Preferably, an incorrect PIN may be entered only three times at which time the device 1 is disabled.

With reference to FIGS. 3 and 4, data card information or other diverse types of information which are stored in the HSM may be input into the electronic card device 1 with a card swipe 30, the global platform smart card device 26, a NUMI Key system 32 or optical reading entry. The electronic card device 1 is electrically connected to and retained in a card swipe 30, which allows information from a card 100 with a magnetic stripe to be entered into the electronic card device 1. Magnetic card swipes are well known and need not be explained in detail. Data from the magnetic stripe of the card 100 is input into the CPU/processor 12 and stored in the HSM memory device 20, such as micro SD card.

The global platform smart card device 26 is resident in the electronic card device. The well-known global platform smart card device 26 reads or inputs data cards with RFID/NFC chips into the electronic card device 1. The well-known NUMI Key system 32 (describes numikey.com) is preferably resident in the electronic card device 1. The NUMI Key system 32 reads or inputs bar code loyalty cards into the electronic card device 1. The manual entry of data occurs through a electronic device, such as a personal computer or smart phone. Information from the data card or other sources which is to be stored in encrypted form in the HSM and only output to another device (peer-to-peer) or to a network is input into the CPU and stored in the HSM device 20.

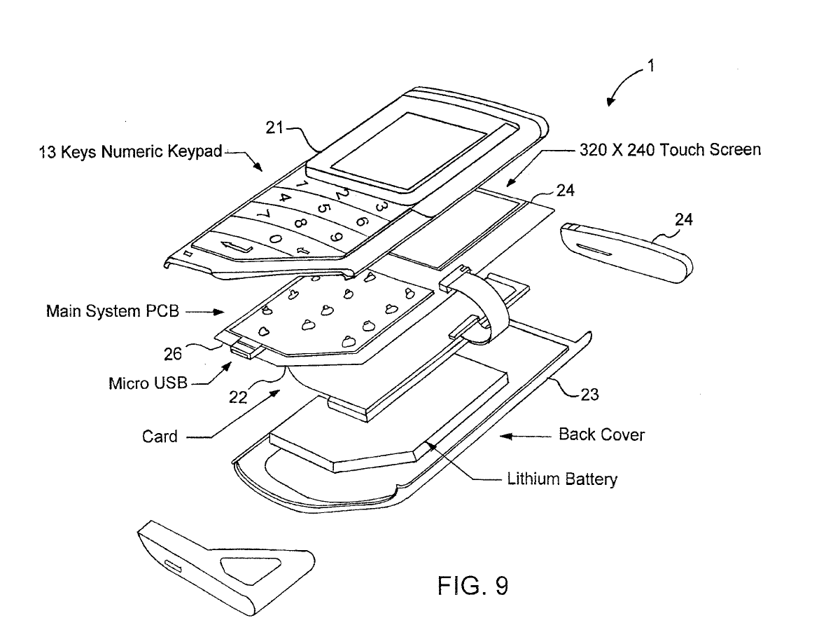

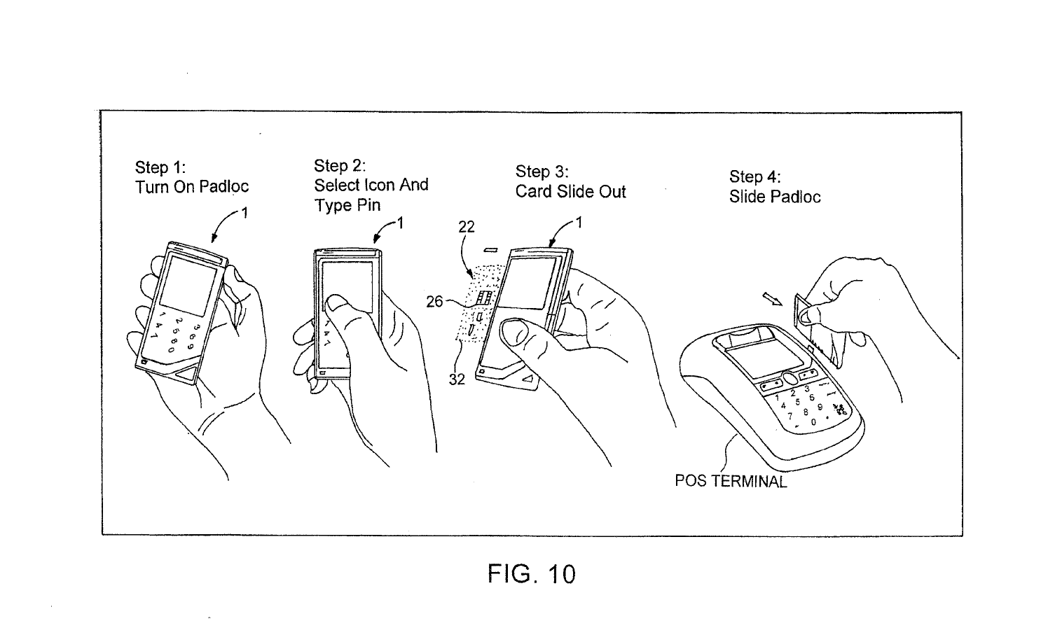

The operating system 14 displays the data cards or other information retained in the HSM memory device 20 through the screen display 18 that may be transmitted after authentication of the user by inputting provisioned and authenticated PINS. Card or other information that is stored in encrypted format, in accordance with the above standard in the HSM memory device 20, is transmitted (or presented) through the transmission element 22, the global platform smart card device 26 or the NUMI Key system. The transmission element 22 preferably includes a programmable magnetic stripe 32 and a programmable Europay Master Card Visa integrated circuit (programmable EMV integrated circuit) 34. The transmission element 22 is preferably slidable and is retained in the rear case half 23 as shown in FIGS. 9 and 10. The transmission element 22 is slid from a retracted position to an extended position with a slide button 36 of FIG. 2.

The programmable magnetic stripe 32 is self-provisioned and temporarily programmed with the same data that is retained in the magnetic stripe of a card. The programmable magnetic stripe 32 is electrically programmed by the CPU 12 to have a binary number, which is the same as the magnetic stripe of the card 100. The programmable EMV integrated circuit 34 is electrically programmed by the CPU/processor 12 to have a binary number, which is the same as the EMV integrated circuit of a European payment card.

The transmission device 22 is read by a card transaction device, such as a point of sale payment card reader (Illustration 10). The programmable magnetic stripe 32 only retains data of the card for one swipe of the point of sale payment card reader. The global platform smart card device 26 writes or transmits a nearfield communication (NFC) image to a nearfield communication (NFC) reader plate. The NUMI Key system 32 is capable of writing bar code information into the HSM from a bar code loyalty card to a bar code reading device.

Each electronic device 1 includes a unique identification number. A user who buys an electronic device 1 is assigned a code by a third party verification organization. The third party verification organization establishes the identity of the user through an authentication process, similar to how a payment card company establishes the identity of a payment card owner. The electronic card device also includes a SIM (Subscriber Identification Module) card 38, which is also verified by the third party verification organization during the authentication process.

Additionally, the electronic device 1 may be tethered to a mobile phone or a personal computer. The electronic device 1 may also be used as a point of sale payment card reader for performing payment card transactions.

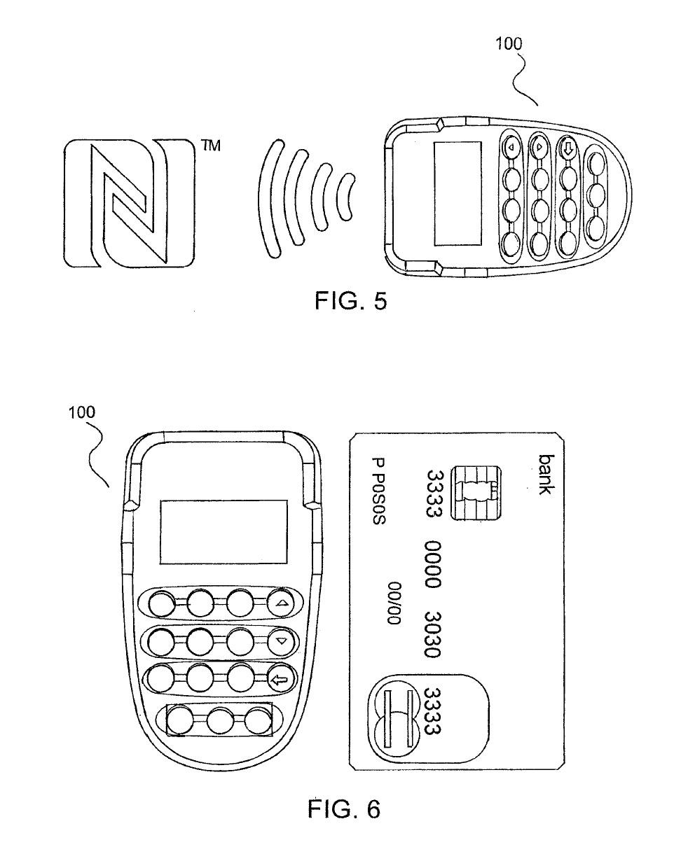

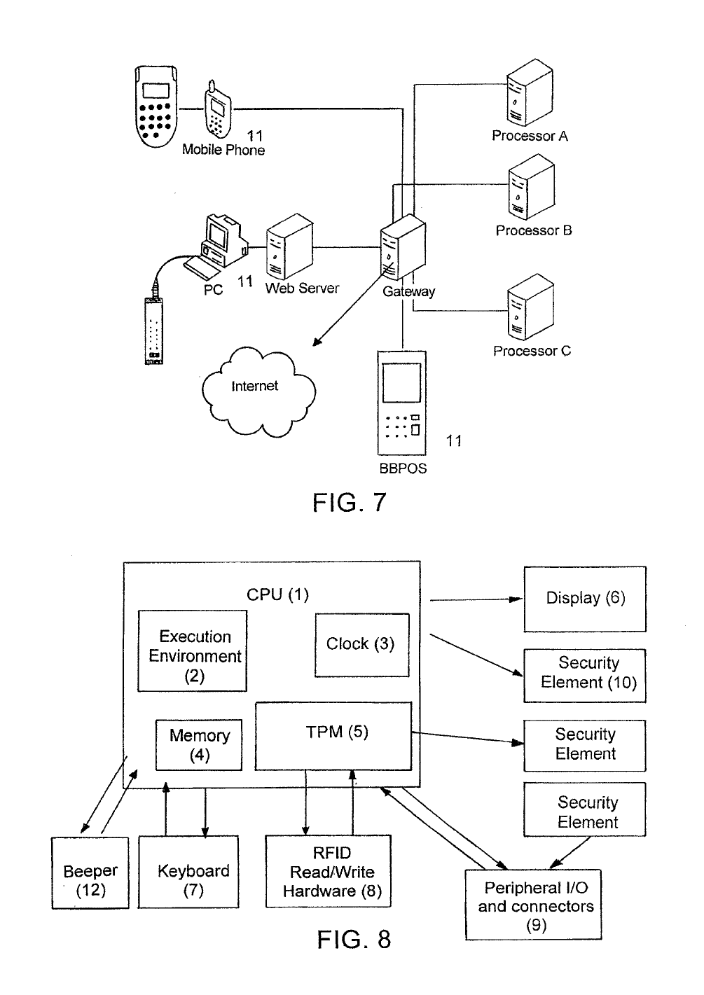

FIGS. 5-8 illustrate a second embodiment 100 of the invention in which FIG. 5 illustrates the second embodiment 100 scanning a sticker; FIG. 6 illustrates the second embodiment 100 compared to the size of a conventional payment card; FIG. 7 illustrates a schematic view of the second embodiment 100 computing an actual transaction, and FIG. 8 illustrates an electronic schematic diagram of the second embodiment of the invention.

The second embodiment 100 of the invention facilitates the functions specified above very inexpensively, very simply, and without the need for a specific cellular handset which has built in NFC/RFD protocols. The invention itself will enable a user to load multiple payment card instruments and to secure those data's with a personal identification number (PIN) so that if the invention is misplaced, lost or stolen the card information that has been input will be secured by the PIN. This embodiment of the invention will also allow a user to touch or come in appropriate proximity with an NFC/RFID sticker to gather the information on the sticker or apply new data to an existing sticker and have that data read asynchronously or synchronously with a network connected terminal. An example is a user, upon seeing the sticker below the painting in the museum, merely and quickly retrieves the data from the NFC/RFID sticker or ads a comment to the information upon that sticker but the user will not be able to upload the information that he or she has taken or added to the sticker until the invention is connected to a network terminal such as a cellular phone, a PC, or a set top box, etc.

The benefit of the embodiments of the invention is that because they will only perform one task at a time and all the data is secured in hardware within the device in a layer of security heretofore not in existence. In essence the embodiments behave much like an older technology, the floppy disk, where one might compose a document on one computer, save the information to the floppy disk, move the floppy disk to another computer for editing or printing, thereby creating what was formerly known as “a sneaker network”. Of course, without some encryption methodology, the floppy disk if lost, stolen, or found by an undesired or adversarial user could have its contents abused, stolen, or altered. By adding the necessity or the option for the user to protect the data collected on their device with a PIN, the risk of secure data being abused is reduced to near zero.

The second embodiment of the invention is a simple device for consumers and/or merchants to read (8′, 9′), manipulate (2′, 5′), add (2′, 5′), combine (2′), create and write (2′, 4′, 7′, 8′, 9′) data which can easily and securely be stored (4′, 5′) on the device for both asynchronous and synchronous coupling (8′, 9′) to a network connected terminal (11′) for storage or synchronous transmission over a network, for, but not limited to, remote storage of collected data and/or transaction processing. Combining data can mean the use of data generated on the device and combining it with data read from external sources by the device by adding a time stamp (3′) to read data or a PIN to transaction information, as well as tonal beep to acknowledge transfer of data (12′).

This embodiment of the invention improves security in network connected terminals, such as cell phones and PCs, where data can be stored and transmitted asynchronously but not securely because the device has more than one single I/O function allowed at any given time Because the invention preferably has only one single I/O function allowed at any give time, data can be stored, data can be transmitted, data can be collected, but none of these functions can occur simultaneously.

Embodiment 100 of the invention embodies a similar concept to a “sneaker-network” or a USB thumb drive where data can be stored and it may or may not be encrypted. This embodiment 100 of the invention can take one schema of encryption and internally convert that schema to any other schema without exposing any data. All data are hardware encrypted at military and financial institution grade security and the datas are only useful at the discretion of the user by entry of a PIN or some other some other authentication method such as biometrics and the like.

Unlike current solutions where data is moved unidirectionally from memory storage to the network, both embodiments of the invention are bidirectional and can receive data from the network or another device (peer-to-peer) as well.

FIG. 9 illustrates an exploded view of the first embodiment of the device 1 present invention. The front cover 21 and the back cover 23, when assembled, provide the device of FIG. 1.

FIG. 10 illustrates the four-step process in which the first embodiment 1 is used. At the first step, the first embodiment is turned on. At the second step, the particular data source, such as, but not limited to, selection of a payment card by selecting a displayed ICON, such as a payment card logo is followed by typing in of the PIN of the user. If the typed in PIN matches the required PIN for the selected ICON representing the information source, then the information stored in the HSM is enabled to be outputted via the means of the transmission element 22 via integrated circuit 26 or the magnetic stripe 32 to a terminal device, such as a POS, as illustrated in step 4. Any one of the information output capabilities may be chosen by the user.

In FIG. 10 as it relates to FIG. 4, Step 1, the device 1 is turned on stimulating battery 25 to instantiate CPU 12 which activates the operating system and display 19. A selection from display 19 and the input of a correct PIN on keypad 16 after validation by decryption 28 of data stored in memory 20 enables transmission element 22 for use at point of sale terminal step 4. The default for transmission is equal to the method of input (which could be magstripe read, RFID/NFC read, manual keyboard entry via NUMI Key, or read of EMV IC). However, during the presentment stage of transmission element 22, the user could select an alternative presentment different from the device default.

For example, a user may chose to enter a piece of data such as their American Express magstripe data but at the point of sale, the user may chose to present the American Express card as an NFC signal or as an EMV IC presentment. Users shall therefore have the option to output a data differently from the method it was input without changing the desired final result.

As explained above, the user has entered their American Express card magstripe data into the invention as a magstripe read. The data has been encrypted as described in the invention and stored in memory in encrypted format. Now, as the user wishes to make a purchase, IF the point of sale cash register does not have a magnetic stripe reader but instead has either an NFC touch plate or an EMV IC reader, by selecting from the screen the non--default (in this case it would be magstripe) presentment, the user can select an alternate presentment such as NFC or EMV and the point of sale cash register will now sent the data to the network as if that data was presented on the American Express magstripe.

This allows the user and the merchant much more flexibility than is currently available in the current merchant/consumer environment as the invention can behave as a translator of one form of input to a different form of presentment such as the conversion of magstripe data to NFC data.

While the invention has been described in terms of its preferred embodiments, it should be understood that numerous modifications may be made thereto without departing from the spirit and scope thereof.

1. A user hand-held device for securely transmitting stored information from the user hand-held device to another device or network for further processing of the stored information comprising:
a processor unit including a trusted platform module for encrypting and decrypting personal identification numbers of potential users of the user hand-held device to determine if a user inputting a personal identification number is a provisioned and authenticated user of the user hand-held device;
a memory for storing at least one encrypted personal identification number identifying at least one authenticated user of the user hand-held device prior to use of the user hand-held device by the at least one authenticated user;
a pin entry device hard wired to the processor unit in accordance with a payment card industry personal identification number transaction security standard for entry and creation of at least one personal identification number of a potential user of the user hand-held device into an encrypted personal identification number which at a time of use is used to determine if the user of the user hand-held device is authenticated to permit a subsequent data transfer of stored information between the user hand-held device and the another device or the network; and wherein
the processor unit communicates with the pin entry device in accordance with the standard to prevent hacking of the user hand-held device and determines if the user of the hand-held device is an authenticated user of the user hand-held device by comparing the personal identification number entered by the user on the pin entry device to determine if there is a match with at least one authorized stored personal identification number and upon determining that a match exists, the user hand-held device communicates the information between the user hand-held device and the another device or the network.

2. A user hand-held device in accordance with claim 1 wherein the memory comprises a hardware storage module.

3. A user hand-held device in accordance with claim 1 wherein the encrypting and decrypting is in accordance with DUKPT encryption and decrypting.

4. A user hand-held device in accordance with claim 2 wherein the encrypting and decrypting is in accordance with DUKPT encryption and decrypting.

5. A user hand-held device in accordance with claim 1 including a reader of smart cards.

6. A user hand-held device in accordance with claim 1 including a reader of cards having an encoded magnetic strip.

7. A user hand-held device in accordance with claim 2 including a reader of smart cards.

8. A user hand-held device in accordance with claim 3 including a reader of smart cards.

9. A user hand-held device in accordance with claim 4 including a reader of smart cards.

10. A user hand-held device in accordance with claim 2 including a reader of cards having an encoded magnetic strip.

11. A user hand-held device in accordance with claim 3 including a reader of cards having an encoded magnetic strip.

12. A user hand-held device in accordance with claim 4 including a reader of cards having an encoded magnetic strip.

13. A user hand-held device in accordance with claim 5 including a reader of cards having an encoded magnetic strip.

14. A user device for securely transmitting stored information from the user device to another device or network for further processing of the stored information comprising:
a processor unit including a trusted platform module for encrypting and decrypting personal identification numbers of potential users of the user device to determine a user inputting a personal identification number is a provisioned and authenticated user of the user device;
a memory for storing at least one encrypted personal identification number identifying at least one authenticated user of the user device prior to use of the user device by the at least one authenticated user;
a pin entry device hard wired to the processor for entry and creation of at least one personal identification number of a potential user of the user device into an encrypted personal identification number block which at a time of use is used to determine if the user of the hand-held device is authenticated to permit a subsequent data transfer of the stored information between the device and the another device or the network; and wherein
the processor unit communicates with the pin entry device and determines if the user of the user device is an authenticated user of the user device by comparing the personal identification number entered by the user on the pin entry device to determine if there is a match with at least one authorized stored personal identification number and upon determining that a match exists, the user device communicates the information between the user device and the another device or the network.

15. A user device in accordance with claim 14 wherein the memory comprises a hardware storage module.

16. A user device in accordance with claim 14 wherein the encrypting and decrypting is in accordance with DUKPT encryption and decrypting.

17. A user device in accordance with claim 15 wherein the encrypting and decrypting is in accordance with DUKPT encryption and decrypting.

18. A user device in accordance with claim 14 including a reader of smart cards.

19. A user device in accordance with claim 14 including a reader of cards having an encoded magnetic strip.

20. A user device in accordance with claim 15 including a reader of smart cards.

21. A user device in accordance with claim 16 including a reader of smart cards.

22. A user device in accordance with claim 17 including a reader of smart cards.

23. A user device in accordance with claim 15 including a reader of cards having an encoded magnetic strip.

24. A user device in accordance with claim 16 including a reader of cards having an encoded magnetic strip.

25. A user device in accordance with claim 17 including a reader of cards having an encoded magnetic strip.

26. A user device in accordance with claim 18 including a reader of cards having an encoded magnetic strip.

27-34. (canceled)
